(19) United States
(12) Patent Application Publication
(10) Pub. No.: US 2006/0128363 A1
(43) Pub. Date: Jun. 15, 2006

(54) Devices and systems for automatic information exchange between communication terminals and electronic databases

(76) Inventors: Jill F. Cooling, St. Louis, MO (US); David Michael Keckley, Livermore, CA (US)

Correspondence Address: MATTHEW E. BURR;LAKE AUSTIN MARINA, 2219 WESTLAKE DR, STE 200, AUSTIN, TX, 78746, US

(21) Appl. No.: 11/011,763

(22) Filed: Dec. 14, 2004

(51) Int. Cl. H04L 12/58

(52) U.S. Cl. 455/412.1

(57) ABSTRACT

Devices and methods to automatically exchange information over the internet between a communication terminal and an online database to provide information backup for the communication terminal, to provide information updates to the database, or to copy information in the database to the communication terminal, by automatically exchanging information between an online database and a communication terminal.

### FIELD OF THE INVENTION

The present invention relates to communications terminals such as cell phones and to personal information electronic databases, and particularly to terminals that automatically backup and download contact information to and from, respectively, an electronic database.

### BACKGROUND OF THE INVENTION

Living in a fast paced world, the need for information, especially contact information, is valuable to busy people. Many of these people rely on their cell phone contact database to store and retrieve this valuable information. Most people, however, do not back up their contact information to a safe medium. So, losing a cell phone or forgetting it at home can be detrimental to an individual subscriber, a small business, or any person or entity who desires to communicate.

Furthermore, when a customer buys a home phone, cell phone, computer, or contact software, often the biggest customer frustration is manually entering their contact phone numbers and other information into the device's memory or a database.

Devices for storing telephone numbers and names associated therewith, according to an alphabetic hierarchy of the names, are disclosed in Hagelberger et al U.S. Pat. No. 3,242,470. Similarly, Fujimura U.S. Pat. No. 4,104,717 provides a telephone information retrieval system in which each entry includes name, address and other information, while Roberts U.S. Pat. No. 4,118,788 discloses associated retrieval data, such as a telephone directory listing of numbers, along with names, addresses and the like.

Likewise, a number of commercially available contact information storage and retrieval computer software and devices are well known to those skilled in the art and to the general public. Such contact information management software and devices, however, fail to provide the functionality of automatic backup to a secure online database medium, nor do they provide the ability to download information from an online database to a communication terminal such as a cell phone. The present invention addresses these and other short-comings of the state of the art.

### BRIEF DESCRIPTION OF THE DRAWING

The present invention is further described in the detailed description that follows, by reference to the noted drawing, by way of non-limiting examples of embodiments of the present invention, in which reference numerals represent similar features throughout the view of the drawing, and in which:

FIG. 1 is a schematic flow chart logic diagram of a specific embodiment of the present invention.

### DETAILED DESCRIPTION

In view of the foregoing, the present invention, through one or more of its various aspects, embodiments and/or specific features or sub-components, is thus intended to bring out one or more of the advantages that will be evident from the description. The present invention is described with frequent reference to cell phones and databases. It is understood that a cell phone or electronic database is merely an example of a specific embodiment of the present invention, which is directed broadly to communication terminals and databases, together with attendant networks, systems and methods within the scope of the invention. The terminology, therefore, is not intended to limit the scope of the invention.

Instead of storing phone book and contact information only on a SIM (Smart) card or in a cell phone memory, where if lost or forgotten it is inaccessible, a backup of contact information is automatically uploaded to a secure database having the customer's phone number as the primary security key. If the phone is lost, stolen or forgotten, the contact information can be securely accessed online with a user name and password, providing valuable information in a time of need. When a new phone of the present invention is purchased by a customer or subscriber the contact information in the database is automatically populated in the new cell phone memory.

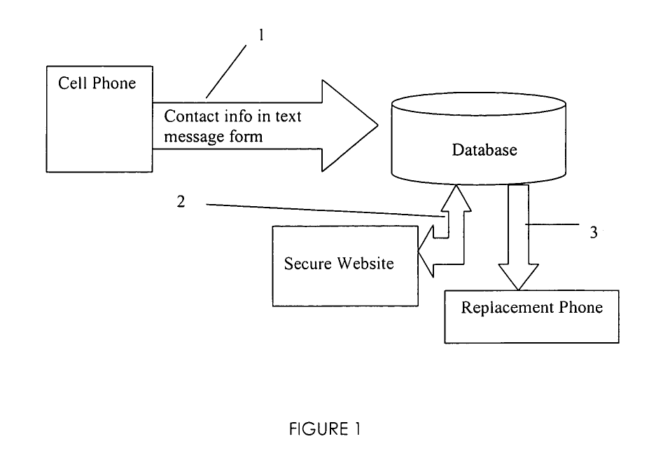

Turning now to FIG. 1, FIG. 1 is a schematic flow chart logic diagram of a specific embodiment of the present invention. A user's cell phone contains contact information, such as received telephone numbers and dialed telephone numbers, the names of people who called or who were called, and possibly additional contact information. This information is retained, at least temporarily, in the memory of the cell phone.

The information is automatically transmitted to an online database 100 and entered into the user's database using the cell phone's phone number as the primary key to access the user's database. In the embodiment of FIG. 1, for example, the data is transmitted automatically in text message form. The invention contemplates a variety of transmission modes, however, including email and Internet Protocol communication. Furthermore, the invention supports POTS telephones, VoIP terminals, wireless and wireline terminals, and so forth.

The transmitted data automatically populates the database and is saved to a secure website 200. The user may access the data from the secure website using a password or any of a variety of secure access measures known in the art. The user's database is accessible via phone, computer, and internet devices such a BlackBerry™ or PDA or internet-enabled television.

The present invention further provides an online database to which a subscriber can dial in, or otherwise retrieve the database URL, and download the contact information directly into your home phone, cell phone, or computer.

When the user acquires a new or replacement cell phone, the contact information stored in the database is automatically downloaded to the new terminal 300 and stored in the terminal's memory. Accordingly, the user's contact information is always up-to-date in the user's communication terminals and computers or internet devices.

A database of the present invention may be distinguished from databases that store phone numbers for dialing. In the later databases, a user dials into the database and dials out from there. The present invention, by contrast, provides a universal location for one's contact numbers, which are downloaded to one's telephone, cell phone, or computer. Whenever a user dials a contact, the user dials from their own phone or communication terminal. There is no need to dial or access the database.

The database of the present invention is web based and updatable via internet access. Users enter their contact information to a database on a website. In particular embodiments of the invention, the database can be downloaded via the web to computers and cell phones. The database is also downloadable and updateable via telephone access, such as, for example, using the Dual Tone Multi-Frequency (DTMF) or Touch Tone keys.

DTMF is the system used by touch-tone telephones. DTMF assigns a specific frequency (consisting of two separate tones) to each key so that it can easily be identified by a microprocessor. Touch Tone access would be suitable for embodiments of the invention such as telephones and cell phones that do not have internet access functionality.

The Internet Protocol (IP) is a data-oriented protocol used by source and destination hosts for communicating data across a packet-switched network. Data in an IP network is sent in blocks referred to as packets or datagrams. Packet switches, or network routers, forward IP datagrams across interconnected layer 2 networks. IP is the common element found in the public Internet.

Addressing refers to assigning an IP address to the end host and to dividing and grouping subnetworks of IP host addresses together. IP routing is performed by all hosts, but most importantly by network routers, which typically use either interior gateway protocols (IGPs) or external gateway protocols (EGPs) to make IP datagram forwarding decisions across IP connected networks.

The definitions of the terms upload and download depend on the context. Download and upload refer to the transfer of information between computers, or any electronic information management devices. The person or device sending the information refers to the transfer as an upload, while the person or device receiving the information refers to it as a download.

To an ISP customer that is sending information, it is an upload; if the customer is receiving information, it is a download. The term download is commonly used to refer to receive a file, and upload to send a file, over the Internet. In either case, information is transferred both ways to manage the download.

The term download is not usually used to refer to simply bringing up a web page in a browser window. Rather, it refers to transferring a larger file and/or directly saving it. Download does not usually refer to copying files from one network device to another even if one computer is acting as a host. For purposes of the present invention, however, information exchange, be it upload or download, may indeed also refer to information copying from one network location of device to another, depending on the context.

The File Transfer Protocol (FTP), for example, is a software standard for transferring computer files between machines with different operating systems. FTP belongs to the application layer of the Internet protocol suite.

FTP is an 8-bit client-server protocol, capable of handling any type of file, such as MIME or Uuencode, without further processing. FTP is commonly run on two ports, 20 and 21. Port 20 is a data stream which transfers the data between the client and the server. Port 21 is the control stream and is the port where commands are passed to the FTP server.

FTP operates in two modes active and passive. Active mode requires both the client and the server to open a port and listen on it in order to establish an FTP session. Passive mode was created to solve active mode problems due to client-side firewalls. Passive mode requires only the server to listen on a port, and thus bypasses firewall issues on the client computer.

Most web browsers and file managers can connect to FTP servers. This allows manipulation of remote files over FTP through an interface similar to that used for local files. This is done via an FTP URL. A password can optionally be given in the URL. Most web-browsers require the use of passive mode FTP, which not all FTP servers are capable of handling.

The FTP protocol is standardized in RFC 0959 by the IETF as: RFC 0959 File Transfer Protocol (FTP). J. Postel, J. Reynolds. October 1985. (Format: TXT, 147316 bytes at http://www.ietf.org/rfc/rfc959.txt).

A file may comprise a database. A database is an information set with a regular structure. Any set of information may be called a database. The term, however, commonly refers to computerized or electronic data.

Software created to manage generalized databases is usually called a Database Management System (DBMS). A variety of DBMS software architectures exist. Smaller, single user, databases are often managed by one program. In larger and multiple user databases, a number of programs are usually involved which, most commonly, adopt a client-server architecture.

The DBMS front-end (i.e., the client) is concerned mainly with data entry, enquiry and reporting. The back-end (i.e., the server) is the set of programs that actually control data storage, responding to requests from the front-end. Searching and sorting is usually performed by the server. There are a wide variety of database implementations, from simple tables stored in a single file each to very large databases with many millions of records, stored in rooms full of disk drives or other peripheral electronic storage devices.

The most useful way of classifying databases is by the programming model associated with the database, several of which are in wide use. The hierarchical model was implemented first, followed by the network model. Most recently, the relational model was developed, with the so-called flat model accompanying it for low-end usage. The relational model exploits mathematical set theory, which provides the model with a more robust theoretical underpinning than the previous database models.

Various techniques are used to model data structure. Certain models are more easily implemented by some types of database management systems than others. For any selected logical model, various physical implementations are possible. The relational model yields examples of this: In larger systems, the physical implementation often has indexes that point to the data; similar in some aspects to common implementations of the network model. In small relational databases, however, the data is often stored in a set of files, one per table, in a flat, unindexed, structure.

The flat (or table) model consists of a single, two-dimensional array of data elements, where all members of a given column are assumed to be similar values, and all members of a row are assumed to be related to one another. For instance, columns for name and password might be used as a part of a system security database. Each row would have the specific password associated with a specific user. Columns of the table often have a type associated with them to define them as character data, date or time information, integers, or floating point numbers. This model is the basis of the spreadsheet.

The network model enables multiple datasets to be used together through the use of pointers (or references). Some columns contain pointers to different tables instead of data. Thus, the tables are related by references, which can be viewed as a network structure. A particular subset of the network model, the hierarchical model, limits the relationships to a tree structure, instead of the more general directed graph structure implied by the full network model.

The relational model was introduced in 1970 by E. F. Codd (http://www.acm.org/classics/nov95/toc.html) as a way to make database management systems more independent of any particular application. The model is mathematically defined in terms of predicate logic and set theory.

Although the basic idea of relational database management systems is very popular, relatively few DBMSs actually implement it completely and without extension. Oracle™, for example, can be used in a purely relational way but it does allow tables to be defined which allow duplicate rows. For purposes of this disclosure, a database is deemed relational if it is in some way inspired by the relational model, not because it conforms to any particular standard.

A relational database contains multiple tables, each similar to the one in the “Flat” database model. Unlike a network database, however, the tables are not linked by pointers. Instead, “keys” are used to match up rows of data in different tables. A key consists simply of one or more columns in a table. Any of the columns in a table may be a key, or multiple columns can be grouped together into a single key. Unlike pointers, it's not necessary to define all the keys in advance. A column, for example, may be used as a key even if it wasn't originally intended to be one.

When a key consists of data that has an external, real-world meaning (such as a person's name, a phone number, a book's ISBN, or a car's serial number), it is called a “natural” key. If no natural key is suitable, an arbitrary key can be assigned (such as, for example, an employee ID number). In practice, many databases have both generated and natural keys. Generated keys may be used internally to create links between rows. Natural keys may be used for searches and for integration with other databases. For example, records in two independently developed databases could be matched up by telephone number.

Data from a relational database may be requested by sending it a query written in a selected language, usually a dialect of SQL. Although SQL was originally intended for end-users, it is quite common for SQL queries to be embedded into user interface software. Many web sites perform SQL queries when generating pages.

In response to a query, the database returns a result set, which is just a list of rows containing the answers. The simplest query is just to return all the rows from a table, but more often, the rows are filtered in some way to return just the answer wanted. Often, data from multiple tables is combined into one, by performing a “join” operation.

Relational databases provide great flexibility, which allows programmers to write queries that were not anticipated by the database designers, and can be used across multiple applications in ways the original designers did not foresee. Accordingly, implementation of relational databases has become very popular with businesses.

All of these kinds of databases can take advantage of indexing to increase their speed. The most common kind of index is a sorted list of the contents of some particular table column, with pointers to the row associated with the value. An index allows a set of table rows matching selected criteria to be located quickly. Various methods of indexing are commonly used, including b-trees, hashes, and linked lists.

Many different algorithms are available for relational DBMSs to compute the result of an SQL statement. Some of the algorithms that solve joins, for example, include Nested Loops Join, Sort-Merge Join and Hash Join.

Object-oriented programming has been applied to databases, creating a new programming model known as object databases. These databases attempt to overcome some of the difficulties of using objects with the SQL DBMSs. An object-oriented program allows objects of the same type to have different implementations and behave differently(polymorphism), so long as they share an interface.

Object databases tend to be used for specialized applications. For general purposes, objects are often stored in SQL databases using mapping software. Some SQL DBMS vendors have added features to allow objects to be stored more conveniently.

Databases are used in many applications, spanning virtually the entire range of computer software. Databases are the preferred method of storage for large multi-user applications, where coordination between many users is needed. Even individual users find them convenient, though, and many electronic mail programs and personal organizers are based on standard database technology.

Concurrency control ensures that transactions are executed in a safe manner and follow the ACID rules (in practice, many DBMS's allow most of these rules to be relaxed to improve performance):

Atomicity—either all or no operations are completed. That is, incomplete transactions are completely undone.

Consistency—all transactions leave the database in a consistent state.

Isolation—transactions do not interfere with each other and incomplete work is invisible to other transactions.

Durability—successful transactions persist through crashes.

A Uniform Resource Locator, URL, or web address, is a standardized IP address for some resource (such as a database, document or image) on the Internet. First created by Tim Berners-Lee for use on the World Wide Web, the currently used forms are detailed by IETF standard RFC 2396 (http://www.ietf.org/rfc/rfc2396.txt) (1998). A database server, for example, often specifies a URL as a parameter to connect to it. Similarly, any Client-Server application following a particular protocol may specify a URL format as part of its communication process. The first part of the address indicates what protocol to use, and the second part specifies the IP address or the domain name where the resource is located.

An IP address is an identifier for a computer or device on a TCP/IP network. Networks using the TCP/IP protocol route messages based on the IP address of the destination. The format of an IP address is a 32-bit numeric address written as four numbers separated by periods. Each number can be zero to 255. For example, 1.160.10.240 could be an IP address.

Within an isolated network, one may assign an IP address at random as long as each one is unique. Connecting a private network to the Internet, however, requires using registered IP addresses (called Internet addresses) to avoid duplicates.

The four numbers in an IP address are used in different ways to identify a particular network and a host on that network. Four regional Internet registries—ARIN, RIPE NCC, LACNIC and APNIC—assign Internet addresses from the following three classes:
Class A—supports 16 million hosts on each of 126 networks
Class B—supports 65,000 hosts on each of 16,000 networks
Class C—supports 254 hosts on each of 2 million networks

The number of unassigned Internet addresses is running out, so a new classless scheme called CIDR is gradually replacing the system based on classes A, B, and C and is tied to adoption of IPv6.

A specific embodiment of the invention provides an online electronic database that includes a URL by which to access the database from a communication terminal, and computer-readable software that enables the database to upload data from the communication terminal automatically, and to automatically autopopulate the database with the data. Embodiments also provide computer-readable software that enables the database to download data to the communication terminal.

Contact information is automatically exchanged between the communication terminal and the online database to provide information backup for the communication terminal, to provide information updates to the database, or to copy information in the database to the communication terminal.

Alternative embodiments provide a communication terminal that includes an electronic memory to store contact information and computer-readable software that enables the terminal to upload data from an online database, and to automatically download data to, and autopopulate, the database with the data. Additionally, the terminal includes computer-readable software that enables the terminal to download data from the database.

Information is automatically exchanged over the internet between the communication terminal and the online database to provide information backup for the communication terminal, to provide information updates to the database, or to copy information in the database to the communication terminal.

Still further embodiments provide an information management system that includes an online electronic database as described above together with a communication terminal as described above. Also contemplated are methods for automatic information exchange over the internet between a communication terminal and an online database to provide information backup for the communication terminal, to provide information updates to the database, or to copy information in the database to the communication terminal by automatically exchanging information between an online database and a communication terminal.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in all its aspects. Although the invention has been described with reference to particular means, materials and embodiments, the invention is not intended to be limited to the particulars disclosed; rather, the invention extends to all functionally equivalent technologies, structures, methods and uses such as are within the scope of the appended claims.

We claim:

1. An online electronic database comprising:
a URL by which to access the database from a communication terminal;
computer-readable software that enables the database to upload data from the communication terminal automatically, and to automatically autopopulate the database with the data; and
computer-readable software that enables the database to download data to the communication terminal,
whereby information is automatically exchanged between the communication terminal and the online database using Internet Protocol to provide information backup for the communication terminal, to provide information updates to the database, or to copy information in the database to the communication terminal.

2. The database of claim 1, wherein the communication terminal transmits the input data by text message.

3. The database of claim 1, further comprising a security key protocol to access the database and wherein a phone number is the primary security key.

4. The database of claim 1, further comprising a security key protocol to access the database, wherein the security key comprises a password.

5. The database of claim 1, further comprising an Internet address to locate the database online.

6. The database of claim 1, further comprising a web browser to display the database.

7. The database of claim 1, wherein the database is accessible across diverse computer platforms, operating systems and web browsers.

8. A communication terminal comprising:
an electronic memory to store contact information;
computer-readable software that enables the terminal to automatically upload data from an online database, and to automatically download data to, and autopopulate, the database with the data; and
computer-readable software that enables the terminal to upload data from the database, whereby information is automatically exchanged over the internet between the communication terminal and the online database to provide information backup for the communication terminal, to provide information updates to the database, or to copy information in the database to the communication terminal.

9. The communication terminal of claim 8, wherein the terminal comprises a cell phone.

10. The communication terminal of claim 8, wherein the terminal comprises a wireline phone.

11. The terminal of claim 8, wherein the data upload from the database to the terminal is automatic.

12. The terminal of claim 8, wherein the automatic data download to the database comprises a text message.

13. The terminal of claim 8, further comprising a microprocessor to run the software.

14. An information management system comprising:
An online electronic database further comprising:
A URL by which to access the database from a communication terminal;
computer-readable software that enables the database to upload data from the communication terminal automatically, and to automatically autopopulate the database with the data; and
computer-readable software that enables the database to download data to the communication terminal; and
a communication terminal further comprising:
an electronic memory to store contact information;
computer-readable software that enables the terminal to automatically upload data from an online database, and to automatically download input data to, and autopopulate, the database with the data; and
computer-readable software that enables the terminal to download data from the database,
whereby information is automatically exchanged over the internet between the communication terminal and the online database to provide information backup for the communication terminal, to provide information updates to the database, or to copy information in the database to the communication terminal.

15. The system of claim 14, further comprising a network that still further comprises the Internet.

16. The system of claim 14, further comprising a web browser to display the data.

17. The system of claim 14, wherein the system is at least partially wireless.

18. The system of claim 14, wherein the information exchange comprises a text message.

19. The system of claim 14, further comprising an Internet address to locate the database online.

20. A method for automatic information exchange over the internet between a communication terminal and an online database to provide information backup for the communication terminal, to provide information updates to the database, or to copy information in the database to the communication terminal, the method comprising:
automatically exchanging information between an online database and a communication terminal.
